(19) United States
(12) Patent Application Publication
(10) Pub. No.: US 2025/0153540 A1
(43) Pub. Date: May 15, 2025

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Jeawan Kim, Hwaseong-si (KR); Hochan An, Hwaseong-si (KR); Soonbeom Kwon, Yongin-si (KR); Yeonho Kim, Seoul (KR); DongJun Shim, Yongin-si (KR); Hoyoung Jeong, Hwaseong-si (KR); Man Hee Park, Suwon-si (KR); Yeong Jun Kim, Incheon (KR); Jae Yeon Kim, Hwaseong-si (KR); Jeong Keun Kim, Gwangmyeong-si (KR)

(73) Assignees: HYUNDAI MOTOR COMPANY, Seoul (KR); KIA CORPORATION, Seoul (KR)

(21) Appl. No.: 18/656,161

(22) Filed: May 6, 2024

(30) Foreign Application Priority Data
Nov. 9, 2023 (KR) 10-2023-0154759

(51) Int. Cl. B60H 1/00

(52) U.S. Cl. CPC B60H 1/00907

(57) ABSTRACT

A heat pump system for a vehicle may include: a compressor; a heating, ventilation, and air-conditioning (HVAC) module; a heat-exchanger; a first expansion valve; a gas injection device; a first valve; a first connection line; and a second connection line. Flow of the refrigerant may be controlled depending on at least one mode for a temperature adjustment of a vehicle interior. As a result, the heat pump system may be capable of improving the cooling and heating performance by increasing the flow amount of the refrigerant by employing a gas injection device configured to selectively operate in at least one mode selected for air conditioning of a vehicle interior.

### CROSS-REFERENCE TO RELATED APPLICATION

This application claims priority to and the benefit of Korean Patent Application No. 10-2023-0154759 filed in the Korean Intellectual Property Office on Nov. 9, 2023, the entire contents of which are incorporated herein by reference.

### BACKGROUND

### (a) Field

The present disclosure relates to a heat pump system for a vehicle. More particularly, the present disclosure relates to a heat pump system for a vehicle capable of improving the cooling and heating performance of a vehicle interior.

### (b) Description of the Related Art

Generally, an air conditioning system for a vehicle includes an air conditioner unit circulating a refrigerant in order to heat or cool an interior of the vehicle.

The air conditioner unit is used to maintain the interior of the vehicle at an appropriate temperature regardless of a change in an external temperature. The air conditioner unit is configured to heat or cool the interior of the vehicle by heat-exchange using a condenser and an evaporator in a process in which a refrigerant discharged by a compressor is circulated back to the compressor through the condenser, a receiver drier, an expansion valve, and the evaporator.

In other words, the air conditioner unit lowers the temperature and humidity of the interior of the vehicle by condensing a high-temperature high-pressure gas-phase refrigerant compressed from the compressor by the condenser, passing the refrigerant through the receiver drier and the expansion valve, and then evaporating the refrigerant in the evaporator in a cooling mode.

In other words, in accordance with a continuous increase in interest in energy efficiency and environmental pollution, the development of an environmentally-friendly vehicle capable of substantially substituting for an internal combustion engine vehicle is desired. The environmentally-friendly vehicle is classified into an electric vehicle driven using a fuel cell or electricity as a power source and a hybrid vehicle driven using an engine and a battery.

In the electric vehicle or the hybrid vehicle among these environmentally-friendly vehicles, a separate heater is not used unlike an air conditioner of a general vehicle. Additionally, an air conditioner used in the environmentally-friendly vehicle is generally called a heat pump system.

The electric vehicle driven by the power source of the fuel cell generates driving force by converting chemical reaction energy between oxygen and hydrogen into electrical energy. In this process, heat energy is generated by a chemical reaction in a fuel cell. Therefore, it is desired to secure the performance of the fuel cell by effectively removing generated heat.

In addition, the hybrid vehicle generates driving force by driving a motor using electricity supplied from the fuel cell described above or an electrical battery, together with an engine operated by a general fuel. Therefore, heat generated from the fuel cell or the battery and the motor should be effectively removed in order to secure the performance of the motor.

Therefore, in the hybrid vehicle or the electric vehicle according to the related art, a cooling means, a heat pump system, and a battery cooling system, respectively, should be configured as separate closed circuits so as to prevent heat generation of the motor, an electric component, and the battery including a fuel cell.

Therefore, the size and weight of a cooling module disposed at the front of the vehicle are increased, and a layout of connection pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain an optimal performance of the battery, a plurality of valves for selectively interconnecting connections pipes are employed. Thus, noise and vibration due to frequent opening and closing operations of the valves may be introduced into the vehicle interior, thereby deteriorating the ride comfort.

In addition, when heating the vehicle interior, the heating performance may deteriorate due to the lack of a heat source, the electricity consumption may be increased due to the usage of the electric heater, and the power consumption of the compressor may be increased.

The above information disclosed in this Background section is only to enhance understanding of the background of the disclosure. Therefore, the Background section may contain information that does not form the prior art that is already known to a person of ordinary skill in the art.

### SUMMARY

The present disclosure provides a heat pump system for a vehicle capable of improving the cooling and heating performance by increasing the flow amount of the refrigerant by employing a gas injection device configured to selectively operate in at least one mode selected for air conditioning of a vehicle interior.

A heat pump system for a vehicle may include: a compressor configured to compress a refrigerant; a heating, ventilation, and air-conditioning (HVAC) module having an internal condenser and an evaporator; a heat-exchanger connected to the compressor via a refrigerant line; and a first expansion valve provided on the refrigerant line between the heat-exchanger and the evaporator. The heat pump system may also include a gas injection device connected to the internal condenser or the heat-exchanger, and configured to selectively expand and flow the refrigerant supplied from the internal condenser, or the refrigerant supplied from the heat-exchanger, to selectively supply a partial refrigerant among the supplied refrigerant to the compressor, and increase a flow amount of the refrigerant circulating the refrigerant line. The heat pump system may also include: a first valve provided on the refrigerant line between the compressor and the heat-exchanger; a first connection line having a first end connected to the first valve and a second end connected to the internal condenser; and a second connection line having a first end connected to the internal condenser and a second end connected to the gas injection device. The flow of the refrigerant may be controlled depending on at least one mode for a temperature adjustment of a vehicle interior.

A heat pump system for a vehicle may further include: a second valve provided on the refrigerant line between the heat-exchanger and the first expansion valve; and a third connection line having a first end connected to the second valve and a second end connected to the second connection line. The heat pump system may also include a fourth connection line having a first end connected to the second valve and a second end connected to the refrigerant line between the compressor and the evaporator.

The gas injection device may include: a gas-liquid separator configured to separate and selectively discharge a gaseous refrigerant and a liquid refrigerant among the supplied refrigerant; a second expansion valve connected to a second end of the second connection line; and a first line having a first end connected to the second connection line between the internal condenser and the second expansion valve and a second end connected to the gas-liquid separator. The gas injection device may further include: a third expansion valve provided on the first line; a second line having a first end connected to the second expansion valve and a second end connected to the gas-liquid separator; and a supply line having a first end connected to the gas-liquid separator and a second end connected to the compressor.

The gas-liquid separator may be operated when the third expansion valve may expand and may supply the refrigerant, in the state of cooling or heating the vehicle interior, and may supply the gaseous refrigerant among the supplied refrigerant to the compressor via the supply line, to increase the flow amount of the refrigerant circulating the refrigerant line.

The gas injection device may further include a third line having a first end connected to the second expansion valve and a second end connected to the refrigerant line between the first valve and the heat-exchanger.

The heat pump system may further include a fifth connection line having a first end connected to the second line between the gas-liquid separator and the second expansion valve and a second end connected to the refrigerant line between the first expansion valve and the evaporator. The heat pump system may further include a fourth expansion valve provided on the fifth connection line.

The at least one mode may include: a first mode for cooling the vehicle interior, in which the gas-liquid separator is operated; a second mode for heating the vehicle interior, in which the gas-liquid separator is operated; a third mode for heating and dehumidifying the vehicle interior, in which the gas-liquid separator is operated; a fourth mode for cooling the vehicle interior, in which the gas-liquid separator is not operated; and a fifth mode for heating the vehicle interior, in which the gas-liquid separator is not operated.

In the first mode, an operation of the first expansion valve may be stopped. The first connection line may be closed by an operation of the first valve. A partial second connection line connected to the internal condenser may be closed. A partial second connection line connected to a second end of the third connection line and connected to the first line may be opened. The third connection line may be opened by an operation of the second valve. The fourth connection line may be closed by the operation of the second valve. The fifth connection line may be opened by an operation of the fourth expansion valve. The refrigerant line connecting the second valve and the first expansion valve may be closed. An operation of the second expansion valve may be stopped. The first line may be opened by an operation of the third expansion valve. A partial second line connecting the gas-liquid separator and a first end of the fifth connection line may be opened. A third line may be closed by the operation of the second expansion valve. The supply line may be opened. Additionally, the gas-liquid separator may supply the gaseous refrigerant among the supplied refrigerant to the compressor via the opened the supply line, and may discharge the liquid refrigerant to the fifth connection line connected to the second line.

The third expansion valve may be configured to expand the refrigerant supplied from the heat-exchanger via the third connection line, the partial second connection line and the first line, and may supply the expanded refrigerant to the gas-liquid separator. The fourth expansion valve may be configured to expand the refrigerant supplied from the gas-liquid separator via the partial second line and the fifth connection line, and may supply the expanded refrigerant to the evaporator.

In the second mode, an operation of the first expansion valve may be stopped. The refrigerant line connecting the first valve and a second end of a third line may be closed by an operation of the first valve. The first connection line may be opened by the operation of the first valve. The second connection line may be opened. The third connection line may be closed by an operation of the second valve. The fourth connection line may be opened by the operation of the second valve. The fifth connection line may be closed by an operation of the fourth expansion valve. The refrigerant line connecting from the second valve to a second end of the fourth connection line may be closed. The first line may be opened by an operation of the third expansion valve. The second line may be opened by an operation of the second expansion valve. The second connection line may not be connected to the second line by the operation of the second expansion valve. The supply line may be opened. The third line may be opened by the operation of the second expansion valve. The gas-liquid separator may supply the gaseous refrigerant among the supplied refrigerant to the compressor via the opened the supply line, and may discharge the liquid refrigerant to the second expansion valve via the second line.

The second expansion valve may be configured to expand the refrigerant discharged from the gas-liquid separator via the second line and may discharge the expanded refrigerant to the third line. The third expansion valve may be configured to expand the refrigerant supplied from the internal condenser via the second connection line and the first line and may supply the expanded refrigerant to the gas-liquid separator. The operation of the fourth expansion valve may be stopped.

In the third mode, an operation of the first expansion valve may be stopped. The refrigerant line connecting the first valve and a second end of a third line may be closed by an operation of the first valve. The first connection line may be opened by the operation of the first valve. The second connection line may be opened. The third connection line may be closed by an operation of the second valve. The fourth connection line may be opened by the operation of the second valve. The fifth connection line may be opened by an operation of the fourth expansion valve. The refrigerant line connecting from the second valve to a second end of the fifth connection line may be closed. The first line may be opened by an operation of the third expansion valve. The second line may be opened by an operation of the second expansion valve. The second connection line may not be connected to the second line by the operation of the second expansion valve. The supply line may be opened. The third line may be opened by the operation of the second expansion valve. A partial refrigerant among the refrigerant discharged from the gas-liquid separator via the second line flows via the fifth connection line. The gas-liquid separator may supply the gaseous refrigerant among the supplied refrigerant to the compressor via the opened the supply line, and may discharge the liquid refrigerant to the second line.

The second expansion valve may be configured to expand a remaining refrigerant among the refrigerant discharged from the gas-liquid separator via the second line and may discharge the expanded refrigerant to the third line. The third expansion valve may expand the refrigerant supplied from the internal condenser via the second connection line and the first line, and may supply the expanded refrigerant to the gas-liquid separator. The fourth expansion valve may be configured to expand the refrigerant supplied from the gas-liquid separator via the second line and the fifth connection line, and may supply the expanded refrigerant to the evaporator.

In the fourth mode, the refrigerant line may be opened by an operation of the first expansion valve such that the compressor, the heat-exchanger, and the evaporator may be interconnected via the refrigerant line. The first connection line may be closed by an operation of the first valve. The second connection line may be closed. The third connection line and the fourth connection line are closed by an operation of the second valve. The fifth connection line may be closed by an operation of the fourth expansion valve. The first line may be closed by an operation of the third expansion valve. The second line may be closed by an operation of the second expansion valve. The supply line may be closed. A third line may be closed by the operation of the second expansion valve.

The first expansion valve may expand the refrigerant supplied from the heat-exchanger and may supply the expanded refrigerant to the evaporator. The operation of the second expansion valve, the third expansion valve, and the fourth expansion valve may be stopped.

In the fifth mode, an operation of the first expansion valve may be stopped. The refrigerant line connecting the first valve and a second end of a third line may be closed by an operation of the first valve. The first connection line may be opened by the operation of the first valve. The second connection line may be opened. The third connection line may be closed by an operation of the second valve. The fourth connection line may be opened by the operation of the second valve. The fifth connection line may be closed by an operation of the fourth expansion valve. The refrigerant line connecting from the second valve to a second end of the fourth connection line may be closed. The first line may be closed by an operation of the third expansion valve. The second line may be closed by an operation of the second expansion valve. The supply line may be closed. The third line may be opened by the operation of the second expansion valve. The second connection line may be connected to the third line by the operation of the second expansion valve.

The second expansion valve may be configured to expand the refrigerant supplied from the internal condenser via the second connection line and may discharge the expanded refrigerant to the third line. The operation of the third expansion valve and the fourth expansion valve may be stopped.

The heat-exchanger may be configured to condense the refrigerant supplied in the first mode and the fourth mode.

The heat-exchanger may be configured to evaporate the refrigerant supplied in the second mode, the third mode, and the fifth mode.

The first expansion valve, the third expansion valve, and the fourth expansion valve may be 2-way expansion valves selectively operated in the at least one mode and configured to selectively expand the refrigerant while controlling the flow of the supplied refrigerant.

As described above, according to a heat pump system for a vehicle according to an embodiment, by employing a gas injection device configured to selectively operate in at least one mode selected for air conditioning of a vehicle interior to increase the flow amount of the refrigerant, the cooling and heating performance may be improved.

In addition, according to the present disclosure, the performance of the system by using the gas injection device may be maximized while minimizing the required components. Accordingly, the system may be streamlined and simplified.

In addition, according to an embodiment, it is possible to reduce manufacturing cost and weight through the simplification of an entire system, and thus improve space utilization.

### BRIEF DESCRIPTION OF THE DRAWINGS

The above and other objects, features, and advantages of the present disclosure should be more apparent from the following detailed description taken in conjunction with the accompanying drawings below.

FIG. 1 is a block diagram of a heat pump system for a vehicle according to an embodiment.

FIG. 2 is an operation diagram according to a first mode for a heat pump system for a vehicle according to an embodiment.

FIG. 3 is an operation diagram according to a second mode for a heat pump system for a vehicle according to an embodiment.

FIG. 4 is an operation diagram according to a third mode for a heat pump system for a vehicle according to an embodiment.

FIG. 5 is an operation diagram according to a fourth mode for a heat pump system for a vehicle according to an embodiment.

FIG. 6 is an operation diagram according to a fifth mode for a heat pump system for a vehicle according to an embodiment.

### DETAILED DESCRIPTION

Embodiments are hereinafter described in detail with reference to the accompanying drawings.

The embodiments disclosed in the present specification and the constructions depicted in the drawings are only example embodiments of the present disclosure, and do not cover the entire scope of the present disclosure. Therefore, it should be understood that there may be various equivalents and variations at the time of the application of this specification.

In order to clarify the present disclosure, parts that are not related to the description have been omitted. Also, the same elements or equivalents are referred to with the same reference numerals throughout the specification.

Also, the size and thickness of each element are arbitrarily shown in the drawings, but the present disclosure is not necessarily limited thereto. Additionally, in the drawings, the thickness of layers, films, panels, regions, and the like, may be exaggerated for clarity.

In addition, unless explicitly described to the contrary, the terms “comprise” and variations such as “comprises” or “comprising”, should be understood to imply the inclusion of stated elements but not the exclusion of any other elements.

Furthermore, terms such as “ . . . unit”, “ . . . means”, “ . . . portions”, “ . . . part”, and “ . . . member” described in the specification, mean a unit of a comprehensive element that performs at least one function or operation.

When a component, device, element, or the like of the present disclosure is described as having a purpose or performing an operation, function, or the like, the component, device, or element should be considered herein as being “configured to” meet that purpose or perform that operation or function.

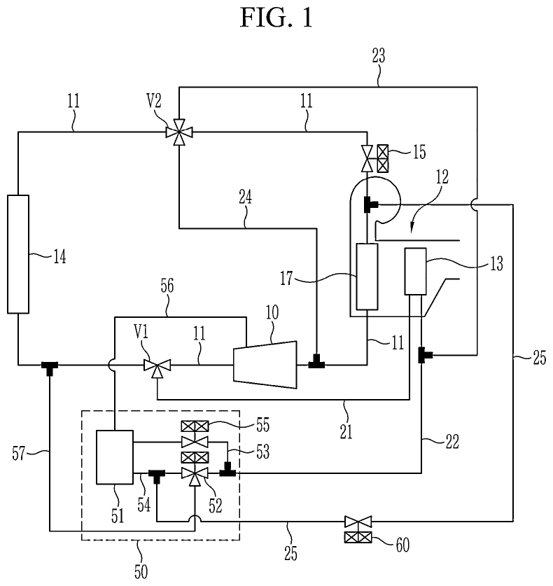

FIG. 1 is a block diagram of a heat pump system for a vehicle according to an embodiment.

According to a heat pump system for a vehicle according to an embodiment, by employing a gas injection device 50 configured to selectively operate in at least one mode selected for air conditioning of a vehicle interior, the cooling and heating performance may be improved.

Referring to FIG. 1, the heat pump system may include a compressor 10, a heating, ventilation, and air-conditioning (HVAC) module 12, an internal condenser 13, a heat-exchanger 14, a first expansion valve 15, an evaporator 17, a first valve V1, a second valve V2, a first connection line 21, a second connection line 22, a third connection line 23, a fourth connection line 24, and the gas injection device 50.

First, the compressor 10 may compress a supplied refrigerant.

The internal condenser 13 and the evaporator 17 connected to the compressor 10 via the refrigerant line 11 may be provided inside heating, ventilation, and air-conditioning Module (HVAC) the module 12.

In the HVAC module 12, the ambient air having passed through the evaporator 17 may flow into the internal condenser 13, depending on a cooling mode, a heating mode, and heat and dehumidifying mode of the vehicle interior.

The heat-exchanger 14 may be connected to the compressor 10 via the refrigerant line 11. The heat-exchanger 14 may selectively condense or evaporate the refrigerant selectively supplied from the compressor 10 through heat-exchange with an operation fluid such as the ambient air or a coolant.

In other words, the heat-exchanger 14 may be configured as an air-cooled or water-cooled heat-exchanger.

The first expansion valve 15 may be provided on the refrigerant line 11 between the heat-exchanger 14 and the evaporator 17.

In the present embodiment, the evaporator 17 may be connected to a first expansion valve 15 via the refrigerant line 11. When the expanded refrigerant is introduced, the evaporator 17 may evaporate the refrigerant by heat-exchange with the air introduced into the HVAC module.

The first valve V1 may be provided on the refrigerant line 11 between the compressor 10 and the heat-exchanger 14.

A first end of the first connection line 21 may be connected to the first valve V1. A second end of the first connection line 21 may be connected to the internal condenser 13.

A first end of the second connection line 22 may be connected to the internal condenser 13. A second end of the second connection line 22 may be connected to the gas injection device 50.

In the present embodiment, the second valve V2 may be provided on the refrigerant line 11 between the heat-exchanger 14 and the first expansion valve 15.

A first end of the third connection line 23 may be connected to the second valve V2. A second end of the third connection line 23 may be connected to the second connection line 22.

A first end of the fourth connection line 24 may be connected to the second valve V2. A second end of the fourth connection line 24 may be connected to the refrigerant line 11 between the compressor 10 and the evaporator 17.

In addition, the gas injection device 50 may be connected to the internal condenser 13 or the heat-exchanger 14.

The gas injection device 50 may selectively expand and flow the refrigerant supplied from the internal condenser 13, or the refrigerant supplied from the heat-exchanger 14.

Simultaneously, the gas injection device 50 may selectively supply a partial refrigerant among the supplied refrigerant to the compressor 10 to increase the overall flow amount of the refrigerant circulating the refrigerant line 11.

The gas injection device 50 may include a gas-liquid separator 51, a second expansion valve 52, a first line 53, a second line 54, a third expansion valve 55, a supply line 56, and a third line 57.

First, the gas-liquid separator 51 may separate and selectively discharge a gaseous refrigerant and a liquid refrigerant among the interiorly introduced refrigerant.

The second expansion valve 52 may be connected to the second end of the second connection line 22.

In the present embodiment, a first end of the first line 53 may be connected to the second connection line 22 between the internal condenser 13 and the second expansion valve 52. A second end of the first line 53 may be connected to the gas-liquid separator 51.

A first end of the second line 54 may be connected to the second expansion valve 52. A second end of the second line 54 may be connected to the gas-liquid separator 51.

The liquid refrigerant discharged from the gas-liquid separator 51 at the time of cooling or heating the vehicle interior may flow to the second line 54 configured as such.

The third expansion valve 55 may be provided on the first line 53. The third expansion valve 55 may selectively expand the refrigerant introduced via the first line 53 and supply the expanded refrigerant to the gas-liquid separator 51.

In other words, the gas-liquid separator 51 may be operated in the case that the third expansion valve 55 expands the refrigerant and supplies the expanded refrigerant, in the state of cooling or heating the vehicle interior.

In the present embodiment, a first end of the supply line 56 may be connected to the gas-liquid separator 51. A second end of the supply line 56 may be connected to the compressor 10.

The supply line 56 configured as such may selectively supply the gaseous refrigerant discharged from the gas-liquid separator 51 to the compressor 10.

The gas-liquid separator 51 may supply the gaseous refrigerant among the supplied refrigerant to the compressor 10 via the supply line 56 to increase the flow amount of the refrigerant circulating the refrigerant line 11.

In addition, a first end of the third line 57 may be connected to the second expansion valve 52. A second end of the third line 57 may be connected to the refrigerant line 11 between the first valve V1 and the heat-exchanger 14.

The heat pump system may further include a fifth connection line 25 and a fourth expansion valve 60.

A first end of the fifth connection line 25 may be connected to the second line 54 between the gas-liquid separator 51 and the second expansion valve 52. A second end of the fifth connection line 25 may be connected to the refrigerant line 11 between the first expansion valve 15 and the evaporator 17.

In addition, the fourth expansion valve 60 may be provided on the fifth connection line 25. The fourth expansion valve 60 may selectively expand the refrigerant introduced into the fifth connection line 25.

The first valve V1 may be a 3-way valve capable of distributing the flow amount while controlling the flow of the refrigerant. In addition, the second valve V2 may be a 4-way valve capable of distributing the flow amount while controlling the flow of the refrigerant.

In addition, the first expansion valve 15, the second expansion valve 52, the third expansion valve 55, and the fourth expansion valve 60 may be selectively operated in at least one mode.

In other words, the first expansion valve 15, the third expansion valve 55, and the fourth expansion valve 60 may be a 2-way expansion valve configured to selectively expand the supplied refrigerant while controlling the flow of the refrigerant.

In addition, the second expansion valve 52 may be a 3-way expansion valve configured to selectively expand the supplied refrigerant while controlling the flow of the refrigerant.

The heat pump system configured as such may control the flow of the refrigerant depending on at least one mode for a temperature adjustment of the vehicle interior.

The at least one mode may include a first mode to a fifth mode.

First, in the first mode, the gas-liquid separator 51 may be operated, and the vehicle interior may be cooled.

In the second mode, the gas-liquid separator 51 may be operated, and the vehicle interior may be heated.

In the third mode, the gas-liquid separator 51 may be operated, and the vehicle interior may be heated and dehumidified.

In the fourth mode, the gas-liquid separator 51 may not be operated, and the vehicle interior may be cooled.

In addition, in the fifth mode, the gas-liquid separator 51 may not be operated, and the vehicle interior may be heated.

The heat exchanger 14 may condense the refrigerant supplied in the first mode and the fourth mode.

To the contrary, the heat-exchanger 14 may evaporate the supplied refrigerant in the second mode, the third mode, and the fifth mode.

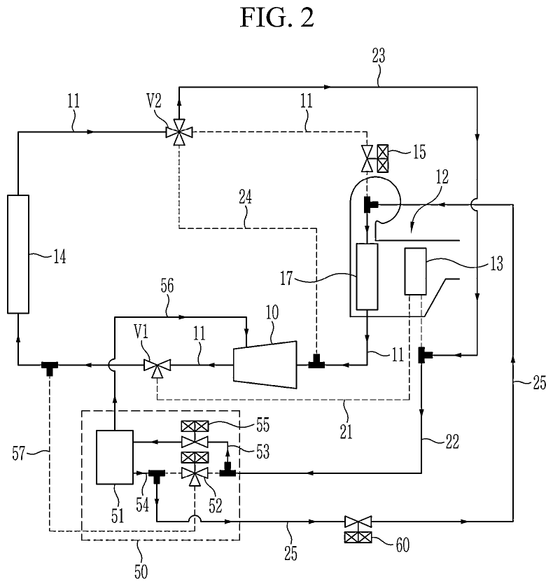

An operation and action in each mode of a heat pump system according to an embodiment configured as such is described in detail with reference to FIG. 2-6.

First, an operation in the first mode for cooling the vehicle interior of a heat pump system according to an embodiment, in which the gas injection device 50 is operated, is described in detail with reference to FIG. 2.

FIG. 2 is an operation diagram according to the first mode for a heat pump system for a vehicle according to an embodiment.

Referring to FIG. 2, in the first mode, in order to cool the vehicle interior, the compressor 10 is operated such that the refrigerant may flow along the refrigerant line 11.

The first expansion valve 15 may stop operating.

Simultaneously, the first connection line 21 may be closed by an operation of the first valve V1.

A partial second connection line 22 connected to the internal condenser 13 may be closed. More specifically, a portion of the second connection line 22 connecting the internal condenser 13 and the second end of the third connection line 23 may be closed.

Simultaneously, the partial second connection line 22 connected to the second end of the third connection line 23 and connected to the first line 53 may be opened. In other words, the second connection line 22 connecting the second end of the third connection line 23 and the first end of the first line 53 may be opened such that the third connection line 23 may be connected to the first line 53.

In the present embodiment, the third connection line 23 may be opened by an operation of the second valve V2. The fourth connection line 24 may be closed by the operation of the second valve V2.

Here, the refrigerant line 11 connecting the second valve V2 and the first expansion valve 15 may be closed by the operation of the first expansion valve 15 and the second valve V2.

In addition, an operation of the second expansion valve 52 may be stopped.

In addition, the fifth connection line 25 may be opened by an operation of the fourth expansion valve 60.

The first line 53 may be opened by an operation of the third expansion valve 55. At the same time, a partial second line 54 connecting the gas-liquid separator 51 and the first end of the fifth connection line 25 may be opened. The supply line 56 may be opened.

In addition, the third line 57 may be closed by the operation of the second expansion valve 52.

Then, the refrigerant introduced into the heat-exchanger 14 from the compressor 10 may be condensed while exchanging heat an operation fluid such as the ambient air or the coolant.

Then, the refrigerant condensed at the heat-exchanger 14 may be introduced into the second valve V2 along the refrigerant line 11. The second valve V2 may flow the refrigerant supplied to the refrigerant line 11 to the third connection line 23.

The refrigerant flowing along the third connection line 23 may flow along the opened partial second connection line 22, and may be introduced into the first line 53.

At this time, the third expansion valve 55 may expand the refrigerant introduced from the heat-exchanger 14 via the third connection line 23, the partial second connection line 22, and the first line 53, and supply the expanded refrigerant to the gas-liquid separator 51.

The gas-liquid separator 51 may supply the gaseous refrigerant among the refrigerant supplied from the third expansion valve 55 via the first line 53 to the compressor 10 via the opened supply line 56.

In other words, the gas injection device 50 may flow the gaseous refrigerant separated while passing through the gas-liquid separator 51 back into the compressor 10 via the supply line 56. Thereby, the gas-liquid separator 51 may increase the flow amount of the refrigerant circulating the refrigerant line 11.

The gas-liquid separator 51 may discharge the liquid refrigerant among the refrigerant supplied via the first line 53 to the fifth connection line 25 connected to the second line 54.

The fourth expansion valve 60 may expand the refrigerant introduced from the gas-liquid separator 51 via the partial second line 54 and the fifth connection line 25 and supply the expanded refrigerant to the evaporator 17.

The ambient air introduced into the HVAC module 12 may be cooled while passing through the evaporator 17 by the low-temperature refrigerant introduced into the evaporator 17.

The cooled ambient air may pass through the internal condenser 13 that is not supplied with the refrigerant, and then directly flow into the vehicle interior, such that the vehicle interior may be cooled.

The refrigerant having passed through the evaporator 17 may be introduced into the compressor 10.

In other words, the refrigerant having passed through the evaporator 17 and the refrigerant supplied from the gas-liquid separator 51 via the supply line 56 may be introduced into the compressor 10. The introduced refrigerant may be compressed by an operation of the compressor 10.

The refrigerant compressed at the compressor 10 may pass through the heat-exchanger 14, and then may flow to the second valve V2 along the refrigerant line 11.

Then, the heat pump system may repeatedly perform the above-described processes.

In other words, while repeatedly performing the above-described operation, the heat pump system may increase the flow amount of the refrigerant flowing along the refrigerant line 11.

In addition, the heat pump system may increase the flow amount of the refrigerant flowing along the refrigerant line 11. Accordingly, the overall cooling performance and efficiency may be improved, and the vehicle interior may be efficiently cooled.

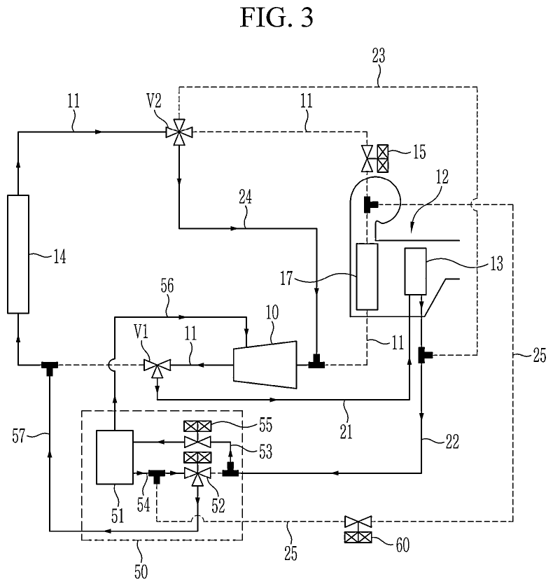

In the present embodiment, an operation according to the second mode for heating the vehicle interior, in which the gas-liquid separator 51 is operated, is described in detail with reference to FIG. 3.

FIG. 3 is an operation diagram according to the second mode for a heat pump system for a vehicle according to an embodiment.

Referring to FIG. 3, in the second mode, in order to heat the vehicle interior, the compressor 10 is operated such that the refrigerant may flow along the refrigerant line 11.

The first expansion valve 15 may stop operating.

Simultaneously, the refrigerant line 11 connecting the first valve V1 and the second end of the third line 57 may be closed by the operation of the first valve V1.

The first connection line 21 may be opened by the operation of the first valve V1. In addition, the second connection line 22 may be opened.

In the present embodiment, the third connection line 23 may be closed by the operation of the second valve V2. The fourth connection line 24 may be opened by the operation of the second valve V2.

The fifth connection line 25 may be closed by the operation of the fourth expansion valve 60. In other words, the fourth expansion valve 60 may stop operating.

The refrigerant line 11 connecting from the second valve V2 to the second end of the fourth connection line 24 may be closed.

The first line 53 may be opened by the operation of the third expansion valve 55. At the same time, the second line 54 may be opened by the operation of the second expansion valve 52.

The second connection line 22 may not be connected to the second line 54 by the operation of the second expansion valve 52.

In addition, the supply line 56 may be opened. In addition, the third line 57 may be opened by the operation of the second expansion valve 52.

Then, the refrigerant discharged from the compressor 10 may be introduced into the internal condenser 13 along the opened first connection line 21. The refrigerant introduced into the internal condenser 13 may be condensed while being heat-exchanged with the ambient air introduced into the HVAC module 12.

The refrigerant discharged from the internal condenser 13 may flow along the second connection line 22, and may be introduced into the first line 53.

At this time, the third expansion valve 55 may expand the refrigerant introduced from the internal condenser 13 via the second connection line 22 and the first line 53 and supply the expanded refrigerant to the gas-liquid separator 51.

The gas-liquid separator 51 may supply the gaseous refrigerant among the refrigerant supplied from the third expansion valve 55 via the first line 53 to the compressor 10 via the opened supply line 56.

In other words, the gas injection device 50 may flow the gaseous refrigerant separated while passing through the gas-liquid separator 51 back into the compressor 10 via the supply line 56. As a result, the gas injection device 50 may increase the flow amount of the refrigerant circulating the refrigerant line 11.

The gas-liquid separator 51 may discharge the liquid refrigerant among the refrigerant supplied via the first line 53 to the second line 54. At this time, the second expansion valve 52 may expand the refrigerant discharged from the gas-liquid separator 51 via the second line 54 and discharge the expanded refrigerant to the third line 57.

The refrigerant flowing via the third line 57 may be introduced into the heat-exchanger 14 via the refrigerant line 11.

At this time, the refrigerant introduced into the heat-exchanger 14 may be evaporated while exchanging heat with an operation fluid such as the ambient air or the coolant.

Then, the refrigerant evaporated at the heat-exchanger 14 may be introduced into the second valve V2 along the refrigerant line 11. The second valve V2 may flow the refrigerant supplied to the refrigerant line 11 to the fourth connection line 24.

The refrigerant flowing along the fourth connection line 24 may be introduced into the compressor 10.

Then, the heat pump system may repeatedly perform the above-described processes.

In other words, the refrigerant evaporated at the heat-exchanger 14 and the refrigerant supplied from the gas-liquid separator 51 via the supply line 56 may be introduced into the compressor 10. The introduced refrigerant may be compressed by the operation of the compressor 10.

The refrigerant compressed at the compressor 10 may be supplied to the internal condenser 13 along the refrigerant line 11 and the opened first connection line 21. The refrigerant supplied to the internal condenser 13 may increase the temperature of the ambient air introduced into the HVAC module 12.

In other words, when passing through the evaporator 17 that is not supplied with the refrigerant, the ambient air introduced from the outside may be introduced at the room temperature state, which has not been cooled. The introduced ambient air may be converted to a high-temperature state while passing through the internal condenser 13 and then introduced into the vehicle interior, thereby implementing heating of the vehicle interior.

As such, according to a heat pump system according to an embodiment, as the gas injection device 50 is operated together, the overall heating performance and efficiency may be improved.

In addition, according to the present disclosure, the heating efficiency and performance may be improved while minimizing the usage of a separate electric heater.

In addition, the gas injection device 50 may increase the flow amount of the refrigerant circulating the refrigerant line 11, and thereby the heating performance may be maximized.

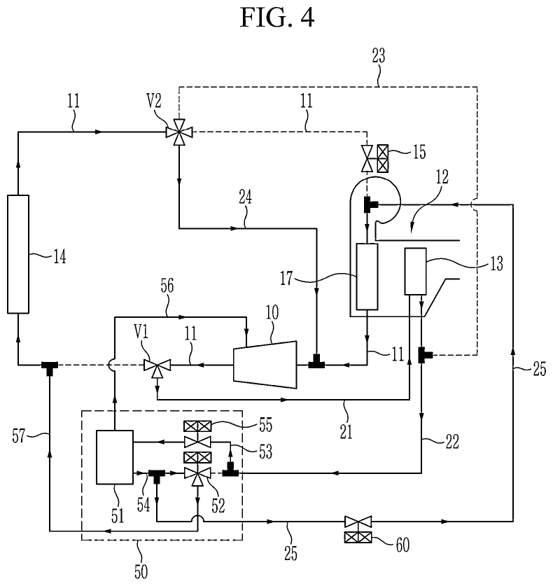

In the present embodiment, an operation according to the third mode for heating and dehumidifying the vehicle interior, in which the gas injection device 50 is operated, is described in detail with reference to FIG. 4.

FIG. 4 is an operation diagram according to the third mode for a heat pump system for a vehicle according to an embodiment.

Referring to FIG. 4, in the third mode, in order to heat and dehumidify the vehicle interior, the compressor 10 is operated such that the refrigerant may flow along the refrigerant line 11.

The first expansion valve 15 may stop operating.

Simultaneously, the refrigerant line 11 connecting the first valve V1 and the second end of the third line 57 may be closed by the operation of the first valve V1.

The first connection line 21 may be opened by the operation of the first valve V1. In addition, the second connection line 22 may be opened.

In the present embodiment, the third connection line 23 may be closed by the operation of the second valve V2. The fourth connection line 24 may be opened by the operation of the second valve V2.

The fifth connection line 25 may be opened by the operation of the fourth expansion valve 60.

The refrigerant line 11 connecting from the second valve V2 to the second end of the fifth connection line 25 may be closed.

The first line 53 may be opened by the operation of the third expansion valve 55. At the same time, the second line 54 may be opened by the operation of the second expansion valve 52.

The second connection line 22 may not be connected to the second line 54 by the operation of the second expansion valve 52.

In addition, the supply line 56 may be opened. In addition, the third line 57 may be opened by the operation of the second expansion valve 52.

Then, the refrigerant discharged from the compressor 10 may be introduced into the internal condenser 13 along the opened first connection line 21. The refrigerant introduced into the internal condenser 13 may be condensed while exchanging heat with the ambient air introduced into the HVAC module 12.

The refrigerant discharged from the internal condenser 13 may flow along the second connection line 22, and may be introduced into the first line 53.

At this time, the third expansion valve 55 may expand the refrigerant introduced from the internal condenser 13 via the second connection line 22 and the first line 53 and supply the expanded refrigerant to the gas-liquid separator 51.

The gas-liquid separator 51 may supply the gaseous refrigerant among the refrigerant supplied from the third expansion valve 55 via the first line 53 to the compressor 10 via the opened supply line 56.

In other words, the gas injection device 50 may flow the gaseous refrigerant separated while passing through the gas-liquid separator 51 back into the compressor 10 via the supply line 56. As a result, the gas injection device 50 may increase the flow amount of the refrigerant circulating the refrigerant line 11.

The gas-liquid separator 51 may discharge the liquid refrigerant among the refrigerant supplied via the first line 53 to the second line 54.

A partial refrigerant among the refrigerant discharged via the second line 54 may be introduced into the fifth connection line 25. At this time, the fourth expansion valve 60 may expand the refrigerant introduced from the gas-liquid separator 51 via the second line 54 and the fifth connection line 25 and supply the expanded refrigerant to the evaporator 17.

Simultaneously, the second expansion valve 52 may expand a remaining refrigerant among the refrigerant discharged from the gas-liquid separator 51 via the second line 54 and discharge the expanded refrigerant to the third line 57.

The refrigerant flowing via the third line 57 may be introduced into the heat-exchanger 14 via the refrigerant line 11.

At this time, the refrigerant introduced into the heat-exchanger 14 may be evaporated while exchanging heat with an operation fluid such as the ambient air or the coolant.

Then, the refrigerant evaporated at the heat-exchanger 14 may be introduced into the second valve V2 along the refrigerant line 11. The second valve V2 may flow the refrigerant supplied to the refrigerant line 11 to the fourth connection line 24.

The refrigerant flowing along the fourth connection line 24 may be introduced into the compressor 10.

Then, the heat pump system may repeatedly perform the above-described processes.

In other words, the refrigerant evaporated at the heat-exchanger 14, the refrigerant supplied from the gas-liquid separator 51 via the supply line 56, and the refrigerant supplied from the evaporator 17 may be introduced into the compressor 10. The introduced refrigerant may be compressed by the operation of the compressor 10.

The refrigerant compressed at the compressor 10 may be supplied to the internal condenser 13 along the refrigerant line 11 and the opened first connection line 21. The refrigerant supplied to the internal condenser 13 may increase the temperature of the ambient air introduced into the HVAC module 12.

In other words, the ambient air introduced into the HVAC module 12 may be dehumidified while passing through the evaporator 17 by the low-temperature refrigerant introduced into the evaporator 17. Thereafter, by being converted to a high-temperature state while passing through the internal condenser 13 and then introduced into the vehicle interior, it may smoothly heat and dehumidify the vehicle interior.

As such, according to a heat pump system according to an embodiment, as the gas injection device 50 is operated together at the time of heating and dehumidification of the vehicle interior, the overall performance and efficiency may be improved.

In addition, according to the present disclosure, the heating efficiency and performance may be improved while minimizing the usage of a separate electric heater.

In addition, the gas injection device 50 may increase the flow amount of the refrigerant circulating the refrigerant line 11, and thereby the heating and dehumidification performance may be maximized.

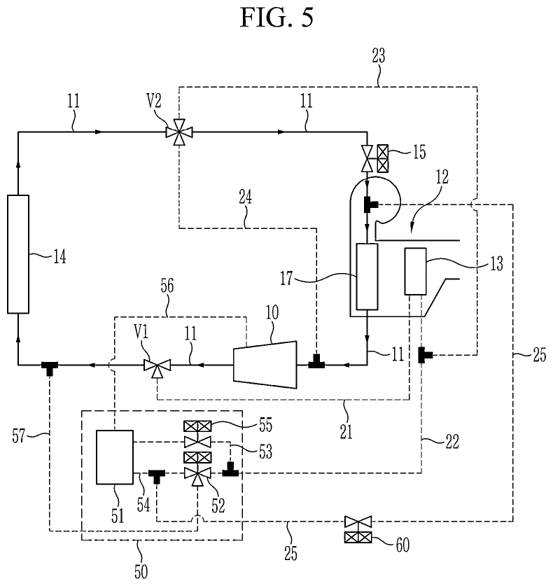

In the present embodiment, an operation according to the fourth mode for cooling the vehicle interior, in which the gas-liquid separator 51 is not operated, is described in detail with reference to FIG. 5.

FIG. 5 is an operation diagram according to the fourth mode for a heat pump system for a vehicle according to an embodiment.

Referring to FIG. 5, in the fourth mode, in order to cool the vehicle interior, the compressor 10 is operated such that the refrigerant may flow along the refrigerant line 11.

The refrigerant line 11 may be opened by an operation of the first expansion valve 15 such that the compressor 10, the heat-exchanger 14, and the evaporator 17 may be interconnected via the refrigerant line 11.

The first connection line 21 may be closed by the operation of the first valve V1. At the same time, the second connection line 22 may be closed.

In addition, the third connection line 23 and the fourth connection line 24 may be closed by the operation of the second valve V2. The fifth connection line 25 may be closed by the operation of the fourth expansion valve 60.

The first line 53 may be closed by the operation of the third expansion valve 55. At the same time, the second line 54 may be closed by the operation of the second expansion valve 52.

In addition, the supply line 56 may be closed. In addition, the third line 57 may be closed by the operation of the second expansion valve 52.

In other words, the operation of the second expansion valve 52, the third expansion valve 55, and the fourth expansion valve 60 may be stopped.

Then, the refrigerant discharged from the compressor 10 may be introduced into the heat-exchanger 14 along the refrigerant line 11. The refrigerant introduced into the heat-exchanger 14 may be condensed while exchanging heat with an operation fluid such as the ambient air or the coolant.

Then, the refrigerant condensed at the heat-exchanger 14 may pass through the second valve V2 along the refrigerant line 11. Thereafter, the refrigerant may be introduced into the first expansion valve 15.

The first expansion valve 15 may expand the refrigerant supplied from the heat-exchanger 14 and supply the expanded refrigerant to the evaporator 17.

In such a state, the ambient air introduced into the HVAC module 12 may be cooled while passing through the evaporator 17 by the low-temperature refrigerant introduced into the evaporator 17. In other words, ambient air cooled while passing through the evaporator 17 may directly flow into the vehicle interior, such that the vehicle interior may be cooled.

The refrigerant having passed through the evaporator 17 may be introduced into the compressor 10. The introduced refrigerant may be compressed by the operation of the compressor 10.

The refrigerant compressed at the compressor 10 may pass through the heat-exchanger 14, and then may be supplied to the first expansion valve 15 along the refrigerant line 11.

Then, the heat pump system may repeatedly perform the above-described processes.

In other words, while repeatedly performing the above-described operation, the heat pump system may efficiently cool the vehicle interior without an operation of the gas injection device 50.

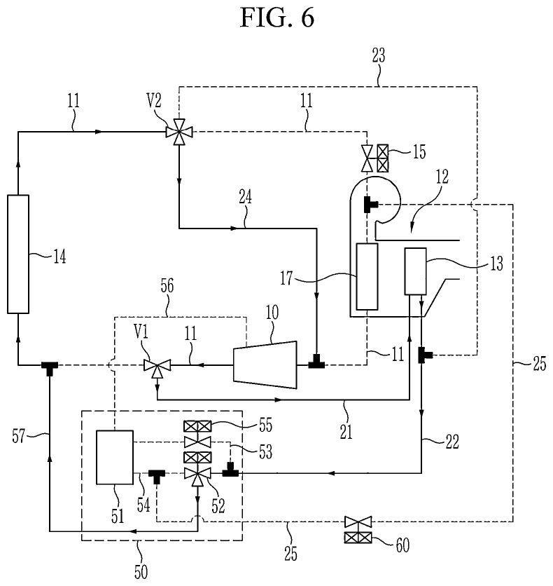

In the present embodiment, an operation according to the fifth mode for heating the vehicle interior, in which the gas-liquid separator 51 is not operated, is described in detail with reference to FIG. 6.

FIG. 6 is an operation diagram according to the fifth mode for a heat pump system for a vehicle according to an embodiment.

Referring to FIG. 6, in the fifth mode, in order to heat the vehicle interior, the compressor 10 is operated such that the refrigerant may flow along the refrigerant line 11.

The first expansion valve 15 may stop operating.

Simultaneously, the refrigerant line 11 connecting the first valve V1 and the second end of the third line 57 may be closed by the operation of the first valve V1.

The first connection line 21 may be opened by the operation of the first valve V1. In addition, the second connection line 22 may be opened.

In the present embodiment, the third connection line 23 may be closed by the operation of the second valve V2. The fourth connection line 24 may be opened by the operation of the second valve V2.

The fifth connection line 25 may be closed by the operation of the fourth expansion valve 60. In other words, the fourth expansion valve 60 may stop operating.

The refrigerant line 11 connecting from the second valve V2 to the second end of the fourth connection line 24 may be closed.

The first line 53 may be closed by the operation of the third expansion valve 55. At the same time, the second line 54 may be closed by the operation of the second expansion valve 52.

The operation of the third expansion valve 55 and the fourth expansion valve 60 may be stopped.

In addition, the supply line 56 may be closed. In addition, the third line 57 may be opened by the operation of the second expansion valve 52.

The second connection line 22 may be connected to the third line 57 by the operation of the second expansion valve 52.

Then, the refrigerant discharged from the compressor 10 may be introduced into the internal condenser 13 along the opened first connection line 21. The refrigerant introduced into the internal condenser 13 may be condensed while exchanging heat with the ambient air introduced into the HVAC module 12.

The refrigerant discharged from the internal condenser 13 may flow along the second connection line 22, and may be introduced into the second expansion valve 52.

The second expansion valve 52 may expand the refrigerant supplied from the internal condenser 13 via the second connection line 22 and discharge the expanded refrigerant to the third line 57.

The refrigerant flowing via the third line 57 may be introduced into the heat-exchanger 14 via the refrigerant line 11.

At this time, the refrigerant introduced into the heat-exchanger 14 may be evaporated while exchanging heat with an operation fluid such as the ambient air or the coolant.

Then, the refrigerant evaporated at the heat-exchanger 14 may be introduced into the second valve V2 along the refrigerant line 11. The second valve V2 may flow the refrigerant supplied to the refrigerant line 11 to the fourth connection line 24.

The refrigerant flowing along the fourth connection line 24 may be introduced into the compressor 10.

Then, the heat pump system may repeatedly perform the above-described processes.

In other words, the refrigerant having passed through the heat-exchanger 14 may be introduced into the compressor 10. The introduced refrigerant may be compressed by the operation of the compressor 10.

The refrigerant compressed at the compressor 10 may be supplied to the internal condenser 13 along the refrigerant line 11 and the opened first connection line 21. The refrigerant supplied to the internal condenser 13 may increase the temperature of the ambient air introduced into the HVAC module 12.

In other words, when passing through the evaporator 17 that is not supplied with the refrigerant, the ambient air introduced from the outside may be introduced at the room temperature state, which has not been cooled. The introduced ambient air may be converted to a high-temperature state while passing through the internal condenser 13 and then introduced into the vehicle interior, thereby implementing heating of the vehicle interior.

As such, according to a heat pump system according to an embodiment, as the gas injection device 50 is operated together, the overall heating performance and efficiency may be improved.

In addition, according to the present disclosure, the heating efficiency and performance may be improved while minimizing the usage of a separate electric heater.

In other words, by repeatedly performing such operations, the heat pump system may heat the vehicle interior without the operation of the gas injection device 50.

Therefore, as described above, when a heat pump system for a vehicle according to an embodiment is applied, the flow amount of the refrigerant may be increased by employing the gas injection device 50 configured to selectively operate in at least one mode selected for air conditioning of the vehicle interior. Thus, the cooling and heating performance of the heat pump system may be improved.

In addition, according to the present disclosure, the performance of the system by using the gas injection device 50 may be maximized while minimizing the required components. Accordingly, the system may be streamlined and simplified.

In addition, according to an embodiment, it is possible to reduce manufacturing cost and weight through simplification of an entire system, and thus improve space utilization.

While this disclosure has been described in connection with what is presently considered to be practical embodiments, it should be understood that the disclosure is not limited to the disclosed embodiments. On the contrary, the disclosure is intended to cover various modifications and equivalent arrangements included within the spirit and scope of the appended claims.

### DESCRIPTION OF SYMBOLS

10: compressor
11: refrigerant line
12: HVAC module
13: internal condenser
14: heat-exchanger
15: first expansion valve
17: evaporator
21: first connection line
22: second connection line;
23: third connection line
24: fourth connection line
25: fifth connection line
50: gas injection device
51: gas-liquid separator
52: second expansion valve
53: first line
54: second line
55: third expansion valve
56: supply line
57: third line
60: fourth expansion valve
V1, V2: first and second valves

What is claimed is:

1. A heat pump system for a vehicle, comprising:
a compressor configured to compress a refrigerant;
a heating, ventilation, and air-conditioning (HVAC) module including an internal condenser and an evaporator;
a heat-exchanger connected to the compressor via a refrigerant line;
a first expansion valve provided on the refrigerant line between the heat-exchanger and the evaporator;
a gas injection device connected to the internal condenser or the heat-exchanger, and configured to selectively expand and flow the refrigerant supplied from the internal condenser, or the refrigerant supplied from the heat-exchanger, to selectively supply a partial refrigerant among the supplied refrigerant to the compressor, and increase a flow amount of the refrigerant circulating the refrigerant line;
a first valve provided on the refrigerant line between the compressor and the heat-exchanger;
a first connection line having a first end connected to the first valve and a second end connected to the internal condenser; and
a second connection line having a first end connected to the internal condenser and a second end connected to the gas injection device,
wherein flow of the refrigerant is controlled depending on at least one mode for a temperature adjustment of a vehicle interior.

2. The heat pump system of claim 1, further comprising:
a second valve provided on the refrigerant line between the heat-exchanger and the first expansion valve;
a third connection line having a first end connected to the second valve and a second end connected to the second connection line; and
a fourth connection line having a first end connected to the second valve and a second end connected to the refrigerant line between the compressor and the evaporator.

3. The heat pump system of claim 2, wherein the gas injection device comprises:
a gas-liquid separator configured to separate and selectively discharge a gaseous refrigerant and a liquid refrigerant among the supplied refrigerant;
a second expansion valve connected to the second end of the second connection line;
a first line having a first end connected to the second connection line between the internal condenser and the second expansion valve and a second end connected to the gas-liquid separator;
a third expansion valve provided on the first line;
a second line having a first end connected to the second expansion valve and a second end connected to the gas-liquid separator; and
a supply line having a first end connected to the gas-liquid separator and a second end connected to the compressor.

4. The heat pump system of claim 3, wherein the gas-liquid separator is operated when the third expansion valve expands and supplies the refrigerant, in a state of cooling or heating the vehicle interior, and supplies the gaseous refrigerant among the supplied refrigerant to the compressor via the supply line, to increase the flow amount of the refrigerant circulating the refrigerant line.

5. The heat pump system of claim 3, wherein the gas injection device further comprises a third line having a first end connected to the second expansion valve and a second end connected to the refrigerant line between the first valve and the heat-exchanger.

6. The heat pump system of claim 3, further comprising:
a fifth connection line having a first end connected to the second line between the gas-liquid separator and the second expansion valve and a second end connected to the refrigerant line between the first expansion valve and the evaporator; and
a fourth expansion valve provided on the fifth connection line.

7. The heat pump system of claim 6, wherein the at least one mode comprises:
a first mode for cooling the vehicle interior, in which the gas-liquid separator is operated;
a second mode for heating the vehicle interior, in which the gas-liquid separator is operated;
a third mode for heating and dehumidifying the vehicle interior, in which the gas-liquid separator is operated;
a fourth mode for cooling the vehicle interior, in which the gas-liquid separator is not operated; and
a fifth mode for heating the vehicle interior, in which the gas-liquid separator is not operated.

8. The heat pump system of claim 7, wherein, in the first mode:
an operation of the first expansion valve is stopped;
the first connection line is closed by an operation of the first valve;
a partial second connection line connected to the internal condenser is closed;
a partial second connection line connected to the second end of the third connection line and connected to the first line is opened;
the third connection line is opened by an operation of the second valve;
the fourth connection line is closed by the operation of the second valve;
the fifth connection line is opened by an operation of the fourth expansion valve;
the refrigerant line connecting the second valve and the first expansion valve is closed;
an operation of the second expansion valve is stopped;
the first line is opened by an operation of the third expansion valve;
a partial second line connecting the gas-liquid separator and a first end of the fifth connection line is opened;
a third line is closed by the operation of the second expansion valve;
the supply line is opened; and
the gas-liquid separator supplies the gaseous refrigerant among the supplied refrigerant to the compressor via the opened the supply line, and discharges the liquid refrigerant to the fifth connection line connected to the second line.

9. The heat pump system of claim 8, wherein:
the third expansion valve is configured to expand the refrigerant supplied from the heat-exchanger via the third connection line, the partial second connection line, and the first line, and supplies the expanded refrigerant to the gas-liquid separator; and
the fourth expansion valve is configured to expand the refrigerant supplied from the gas-liquid separator via the partial second line and the fifth connection line and supplies the expanded refrigerant to the evaporator.

10. The heat pump system of claim 7, wherein, in the second mode:
an operation of the first expansion valve is stopped;
the refrigerant line connecting the first valve and a second end of a third line is closed by an operation of the first valve;
the first connection line is opened by the operation of the first valve;
the second connection line is opened;
the third connection line is closed by an operation of the second valve;
the fourth connection line is opened by the operation of the second valve;
the fifth connection line is closed by an operation of the fourth expansion valve;
the refrigerant line connecting the second valve to the second end of the fourth connection line is closed;
the first line is opened by an operation of the third expansion valve;
the second line is opened by an operation of the second expansion valve;
the second connection line is not connected to the second line by the operation of the second expansion valve;
the supply line is opened;
the third line is opened by the operation of the second expansion valve; and
the gas-liquid separator supplies the gaseous refrigerant among the supplied refrigerant to the compressor via the opened the supply line, and discharges the liquid refrigerant to the second expansion valve via the second line.

11. The heat pump system of claim 10, wherein:
the second expansion valve is configured to expand the refrigerant discharged from the gas-liquid separator via the second line and discharge the expanded refrigerant to the third line;
the third expansion valve is configured to expand the refrigerant supplied from the internal condenser via the second connection line and the first line and supply the expanded refrigerant to the gas-liquid separator; and
the operation of the fourth expansion valve is stopped.

12. The heat pump system of claim 7, wherein, in the third mode:
an operation of the first expansion valve is stopped;
the refrigerant line connecting the first valve and a second end of a third line is closed by an operation of the first valve;
the first connection line is opened by the operation of the first valve;
the second connection line is opened;
the third connection line is closed by an operation of the second valve;
the fourth connection line is opened by the operation of the second valve;
the fifth connection line is opened by an operation of the fourth expansion valve;
the refrigerant line connecting the second valve to the second end of the fifth connection line is closed;
the first line is opened by an operation of the third expansion valve;
the second line is opened by an operation of the second expansion valve;
the second connection line is not connected to the second line by the operation of the second expansion valve;
the supply line is opened;
the third line is opened by the operation of the second expansion valve;
a partial refrigerant among the refrigerant discharged from the gas-liquid separator via the second line flows via the fifth connection line; and
the gas-liquid separator supplies the gaseous refrigerant among the supplied refrigerant to the compressor via the opened the supply line, and discharges the liquid refrigerant to the second line.

13. The heat pump system of claim 12, wherein:
the second expansion valve is configured to expand a remaining refrigerant among the refrigerant discharged from the gas-liquid separator via the second line and discharge the expanded refrigerant to the third line;
the third expansion valve is configured to expand the refrigerant supplied from the internal condenser via the second connection line and the first line and supply the expanded refrigerant to the gas-liquid separator; and
the fourth expansion valve is configured to expand the refrigerant supplied from the gas-liquid separator via the second line and the fifth connection line and supply the expanded refrigerant to the evaporator.

14. The heat pump system of claim 7, wherein, in the fourth mode:
the refrigerant line is opened by an operation of the first expansion valve such that the compressor, the heat-exchanger, and the evaporator may be interconnected via the refrigerant line;
the first connection line is closed by an operation of the first valve;
the second connection line is closed;
the third connection line and the fourth connection line are closed by an operation of the second valve;
the fifth connection line is closed by an operation of the fourth expansion valve;
the first line is closed by an operation of the third expansion valve;
the second line is closed by an operation of the second expansion valve;
the supply line is closed; and
a third line is closed by the operation of the second expansion valve.

15. The heat pump system of claim 14, wherein:
the first expansion valve is configured to expand the refrigerant supplied from the heat-exchanger and supply the expanded refrigerant to the evaporator; and
the operation of the second expansion valve, the third expansion valve, and the fourth expansion valve is stopped.

16. The heat pump system of claim 7, wherein, in the fifth mode:
an operation of the first expansion valve is stopped;
the refrigerant line connecting the first valve and a second end of a third line is closed by an operation of the first valve;
the first connection line is opened by the operation of the first valve;
the second connection line is opened;
the third connection line is closed by an operation of the second valve;
the fourth connection line is opened by the operation of the second valve;
the fifth connection line is closed by an operation of the fourth expansion valve;
the refrigerant line connecting the second valve to the second end of the fourth connection line is closed;
the first line is closed by an operation of the third expansion valve;
the second line is closed by an operation of the second expansion valve;
the supply line is closed;
the third line is opened by the operation of the second expansion valve; and
the second connection line is connected to the third line by the operation of the second expansion valve.

17. The heat pump system of claim 16, wherein:
the second expansion valve is configured to expand the refrigerant supplied from the internal condenser via the second connection line and discharge the expanded refrigerant to the third line; and
the operation of the third expansion valve and the fourth expansion valve is stopped.

18. The heat pump system of claim 7, wherein the heat-exchanger is configured to condense the refrigerant supplied in the first mode and the fourth mode.

19. The heat pump system of claim 7, wherein the heat-exchanger is configured to evaporate the refrigerant supplied in the second mode, the third mode, and the fifth mode.

20. The heat pump system of claim 6, wherein the first expansion valve, the third expansion valve, and the fourth expansion valve are 2-way expansion valves selectively operated in the at least one mode, and configured to selectively expand the supplied refrigerant while controlling the flow of the refrigerant.
